(19) United States
(12) Patent Application Publication
(10) Pub. No.: US 2025/0387815 A1
(43) Pub. Date: Dec. 25, 2025

(54) EYEWEAR CLEANING APPARATUS

(71) Applicant: McGullion Innovations, Rainsville, AL (US)

(72) Inventor: Dirk McGullion, Rainsville, AL (US)

(73) Assignee: McGullion Innovations, Rainsville, AL (US)

(21) Appl. No.: 18/752,085

(22) Filed: Jun. 24, 2024

(51) Int. Cl. B08B 11/02; A46B 13/04; B08B 1/12; B08B 1/30; B08B 1/40; B08B 3/14; G02C 13/00

(52) U.S. Cl. CPC B08B 11/02; A46B 13/04; B08B 1/12; B08B 1/30; B08B 1/40; B08B 3/14; G02C 13/006; A46B 2200/3073

(57) ABSTRACT

An eyewear cleaning apparatus including a housing, a cleaning solution dispenser, a cleaner, and first and second moisture removal units is disclosed. The housing may be configured to receive eyeglasses, and the cleaning solution dispenser may be configured to dispense a cleaning solution on a lens associated with the eyeglasses. The cleaner may be configured to clean the lens when the cleaning solution is being dispended on the lens, and the first moisture removal unit may be configured to remove moisture from the lens after the cleaner cleans the lens. Further, the second moisture removal unit may be configured to dry the lens after the first moisture removal unit removes the moisture from the lens.

### TECHNICAL FIELD

The present disclosure relates to an eyewear cleaning apparatus and more particularly to an eyewear cleaning apparatus that automatically cleans the lenses of eyeglasses.

### BACKGROUND

Many people wear eyeglasses, such as prescription glasses or sun glasses, as per their requirements and personal preferences. Eyeglasses require regular and thorough cleaning to provide the intended benefits to the users. If the lenses of the eyeglasses are not regularly cleaned, smudges may form on the lenses or dirt may get accumulated, resulting in suboptimal view through the glasses for the users. Further, if the lenses are not cleaned in a correct manner, scratches may form on the lenses over time, which may result in permanent damage to the lenses.

It is known that many users are not aware of the best manner to clean the lenses. Further, many users do not regularly clean the lenses, as the conventional lens cleaning process requires manual effort. Therefore, an apparatus is required that facilitates the users in conveniently and efficiently cleaning the lenses.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example first eyewear cleaning apparatus in an open state in accordance with the present disclosure.

FIG. 2 depicts the first eyewear cleaning apparatus of FIG. 1 in a closed state in accordance with the present disclosure.

FIG. 3 depicts a view of a first moisture removal unit of the first eyewear cleaning apparatus of FIG. 1 in accordance with the present disclosure.

FIG. 4 depicts a view of a second moisture removal unit of the first eyewear cleaning apparatus of FIG. 1 in accordance with the present disclosure.

FIG. 5 depicts an example second eyewear cleaning apparatus in an open state in accordance with the present disclosure.

FIG. 6 depicts the second eyewear cleaning apparatus of FIG. 5 in a closed state in accordance with the present disclosure.

FIG. 7 depicts an example third eyewear cleaning apparatus in a first state in accordance with the present disclosure.

FIG. 8 depicts the third eyewear cleaning apparatus of FIG. 7 in a second state in accordance with the present disclosure.

### DETAILED DESCRIPTION

### Overview

The present disclosure describes an eyewear cleaning apparatus (“apparatus”) that may be configured to automatically clean, dry and buff lenses of eyeglasses that may be placed inside the apparatus. The apparatus may include a housing in which a user may place the eyeglasses. The apparatus may further include a cleaner and a cleaning solution dispenser that may be configured to dispense a cleaning solution on the lens when the cleaning solution dispenser is activated. The cleaner may include a plurality of bristles that may touch and clean the lens when the cleaner is activated and when the cleaning solution dispenser may be dispensing the cleaning solution on the lens. The cleaner may be configured to move in a predefined pattern touching the lens, which may enable the cleaner to effectively clean the lens. The predefined movement pattern may include back-and-forth motion, to-and-fro motion and/or circular/spinning motion.

In some aspects, the bristles associated with the cleaner may be configured to dry and buff the lens as well, in addition to cleaning the lens. In other aspects, the apparatus may include one or more separate moisture removal units that remove the moisture off the lens and dry the lens, after the cleaning solution dispenser stops dispensing the cleaning solution and the cleaner stops cleaning the lens. In an exemplary aspect, the apparatus may include a first moisture removal unit that may remove most of the moisture from the lens after the cleaning solution dispenser stops dispensing the cleaning solution and the cleaner stops cleaning the lens. The first moisture removal unit may include a hot air blowing unit, a plurality of bristles, a microfiber cloth, a combination thereof, and/or the like.

The apparatus may further include a second moisture removal unit that may dry the lens after the first moisture removal unit removes most of the moisture from the lens. The second moisture removal unit may be similar to the first moisture removal unit, and may include a completely dry microfiber cloth and/or a plurality of bristles.

In some aspects, the apparatus may further include a holding unit that may be configured to be disposed between eyeglasses temples and an eyeglasses bridge, when the eyeglasses are placed face down in the housing/apparatus. In an exemplary aspect, the holding unit may include the cleaner, the cleaning solution dispenser, and the first and second moisture removal units described above. The apparatus with the holding unit may be specifically beneficial to enable cleaning and drying of eyeglasses that may have a curved shape or eyeglasses in which a considerable distance exists between the temples and the lenses.

In additional aspects, the apparatus may include a first set of hollow cylindrical tubes on a housing top wall, and a second set of hollow cylindrical tubes on a housing bottom wall. Each tube may include an opening through which the cleaning solution that is dispensed by the cleaning solution dispenser may be received in the tube interior portion. The cleaning solution collected in the tube interior portion may be filtered (e.g., by a filtering unit) and then re-circulated in the apparatus for further cleaning cycles.

In some aspects, when the cleaning solution dispenser may be dispensing the cleaning solution and the cleaner may be cleaning the lens, the tube openings may face the lens to effectively receive the cleaning solution. When the cleaning solution dispenser stops dispensing the cleaning solution and the cleaner is deactivated, the tubes may be axially rotated by 180 degrees, so that the tube openings may face away from the lens and the “dry” side of the tubes may face the lens. When the tube's dry side faces the lens, the lens' drying and buffing operation may be performed effectively.

The present disclosure discloses an eyewear cleaning apparatus that automatically cleans and dries the eyeglasses lenses. Since the apparatus performs the cleaning and drying operation automatically, manual effort is considerably reduced. Further, the apparatus uses soft bristles and microfiber cloth for cleaning and drying the lenses, thereby ensuring that the lenses are not scratched during the cleaning operation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

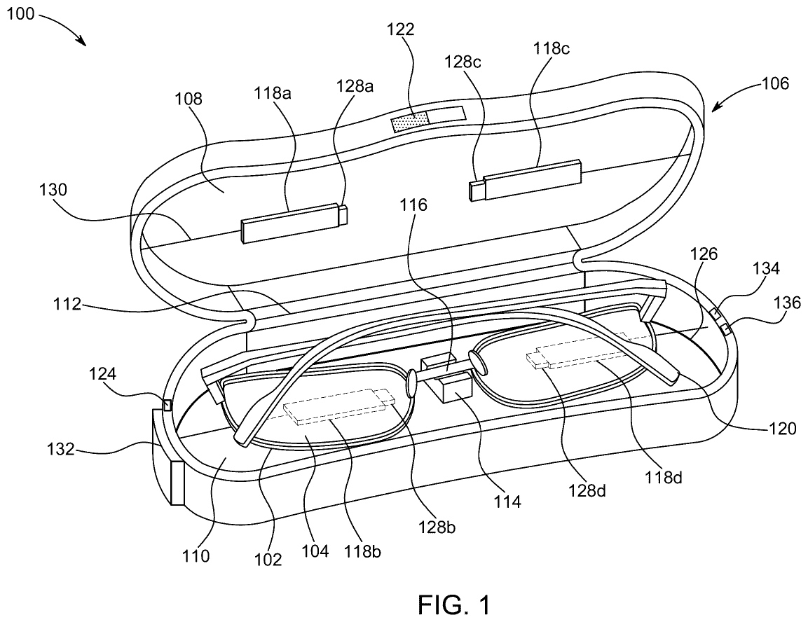

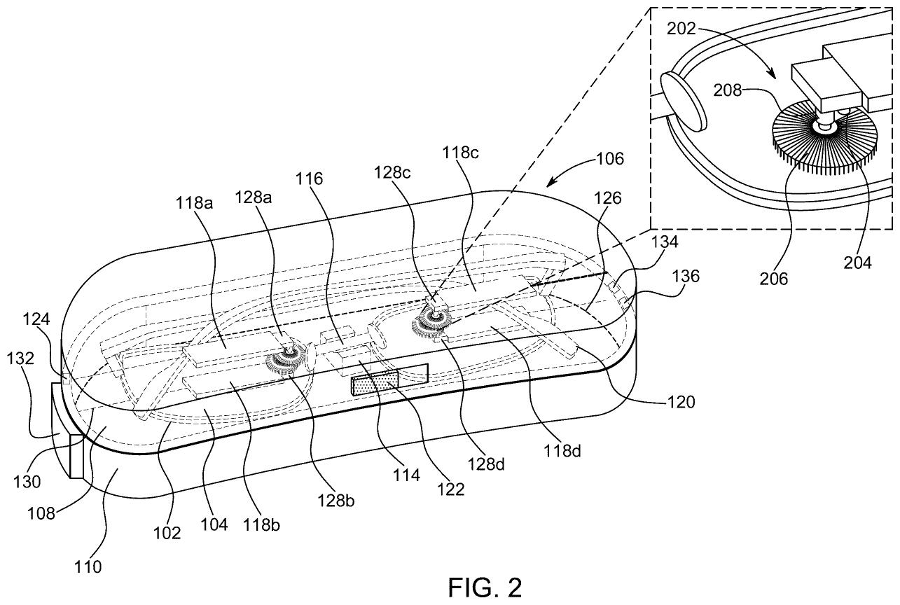

FIG. 1 depicts an example first eyewear cleaning apparatus 100 (or apparatus 100) in an open state in accordance with the present disclosure. FIG. 1 will be described in conjunction with FIGS. 2, 3 and 4. The apparatus 100 may be configured to automatically clean an eyewear or eyeglasses 102 that may be placed inside the apparatus 100. The eyeglasses 102 may be, for example, prescription glasses or sun glasses. Further, the eyeglasses 102 may have any dimension, color and/or shape/design. In some aspects, the apparatus 100 may be configured to clean each lens 104 associated with the eyeglasses 102 from both the sides (e.g., the front and back sides of the lens 104).

In an exemplary aspect, the apparatus 100 may be shaped as a convention eyewear case in which different types of eyeglasses may be stored/placed. In other aspects, the apparatus 100 may have any other shape that may enable a user (not shown) to conveniently place the eyeglasses 102 in the apparatus 100. The apparatus 100 may include a housing 106 that may have a cuboidal or oval shape, and may be configured to receive and store the eyeglasses 102. The housing dimensions may depend on the eyeglasses 102 dimensions/shape. Specifically, the housing dimensions may be large enough for the housing walls to completely engulf or enclose the eyeglasses 102, and no part of the eyeglasses 102 is disposed outside the housing walls when the eyeglasses 102 are placed inside the housing 106.

The housing 106 may include a cover or a housing top wall 108, and a base or a housing bottom wall 110. The housing top and bottom walls 108, 110 may be pivotally connected with each other via a hinge at an intersection edge 112, which may enable the housing top wall 108 to rotate relative to the housing bottom wall 110. In some aspects, the user may move the apparatus 100 to the open state by rotating the housing top wall 108 away from the housing bottom wall 110 via the intersection edge 112. The user may access the housing interior position (or the housing interior position may be exposed) when the apparatus 100 is in the open state, as shown in FIG. 1. In some aspects, a housing top wall plane may not be parallel to a housing bottom wall plane when the apparatus 100 is in the open state.

In a similar manner, the user may move the apparatus 100 to a closed state by rotating and disposing the housing top wall 108 close to the housing bottom wall 110 via the intersection edge 112. The user may not access the housing interior position (or the housing interior position may not be exposed) when the apparatus 100 is in the closed state, as shown in FIGS. 2, 3 and 4. In some aspects, the housing top wall plane may be parallel to the housing bottom wall plane when the apparatus 100 is in the closed state.

The housing bottom wall 110 may include a clip 114 on which an eyeglasses bridge 116 may rest when the eyeglasses 102 are placed in the housing 106 in a face down position, as shown in FIG. 1. The clip 114 may be attached to or disposed in proximity to a center position of the housing bottom wall 110, and may be disposed between the bridge 116 and the housing bottom wall 110 when the eyeglasses 102 are placed in the housing 106. The clip 114 may ensure that a predefined non-zero distance is maintained between the lens 104 and a housing bottom wall interior surface that faces the housing interior portion, when the eyeglasses 102 are placed in the housing 106. Specifically, the clip 114 may have such dimensions that the lens 104 do not touch the housing bottom wall interior surface when the eyeglasses 102 are placed face down in the housing 106, but are instead disposed a predefined non-zero distance away from the housing bottom wall interior surface. In some aspects, the predefined non-zero distance may be same as the distance between the lens 104 and a housing top wall interior surface that faces the housing interior portion, when the eyeglasses 102 are placed in the housing 106 and the apparatus 100 is in the closed state. Stated another way, the lens 104 may be equidistant from the housing bottom wall interior surface and the housing top wall interior surface when the eyeglasses 102 are placed in the housing 106 and the apparatus 100 is in the closed state. In alternative aspects, the lens 104 may not be equidistant from the housing bottom wall interior surface and the housing top wall interior surface, and may be disposed closer to either the housing top wall 108 or the housing bottom wall 110 when the apparatus 100 is in the closed state.

The apparatus 100 may further include eyewear cleaning, drying and buffing units 118a, 118b, 118c, 118d (collectively referred to as unit 118) that may be disposed on the housing top wall interior surface and the housing bottom wall interior surface. In an exemplary aspect, the unit 118a may be disposed at or connected to a left portion of the housing top wall interior surface, and the unit 118b may be disposed at or connected to a left portion of the housing bottom wall interior surface, as shown in FIG. 1. In this configuration, the units 118a, 118b get disposed in proximity to and over (or above) front and back surfaces of the left lens 104 when the eyeglasses 102 are placed in the housing 106 and the apparatus 100 is in the closed position, as shown in FIGS. 2, 3 and 4. Similarly, the unit 118c may be disposed at or connected to a right portion of the housing top wall interior surface, and the unit 118d may be disposed at or connected to a right portion of the housing bottom wall interior surface. In this configuration, the units 118c, 118d get disposed in proximity to and over (or above) front and back surfaces of the right lens 104 when the eyeglasses 102 are placed in the housing 106 and the apparatus 100 is in the closed position. Each unit 118 may include one or more components that may be configured to clean, dry and/or buff the lens 104 during the apparatus operation, as described below.

When the user desires to clean the eyeglasses 102, the user may move the apparatus 100 to the open state and may place the eyeglasses 102 face down in the housing 106 on the clip 114 such that the bridge 116 rests on the clip 114. Thereafter, the user may close eyeglasses temples 120, so that the eyeglasses 102 are placed in the housing 106 in the manner shown in FIG. 1. The user may then move the apparatus 100 to the closed state, and press/activate an ON/OFF switch 122 that may be located on a housing exterior surface of either the housing top wall 108 or the housing bottom wall 110. The switch 122 may be an electronic or an electro-mechanical switch that may cause the apparatus 100 to start operating when the switch 122 is activated.

When the apparatus 100 commences operation, a cleaner 202 (that may be part of the unit 118) may extend or move out from the unit 118, and get disposed in proximity to and over (or above) the lens 104 surface, as shown in FIG. 2. In some aspects, along with the cleaner 202, a cleaning solution dispenser 204 may also get disposed in proximity to and over (or above) the lens 104 surface, when the apparatus 100 commences operation. The cleaning solution dispenser 204 may be configured to dispense a cleaning solution on the lens 104 when the cleaning solution dispenser 204 gets disposed in proximity to and over the lens 104 and when the cleaning solution dispenser 204 is activated. The cleaning solution may be, for example, alcohol, vinegar, water, a combination thereof, or any other lens cleaning liquid/agent. In some aspects, the cleaning solution dispenser 204 may be part of the cleaner 202. In other aspects, the cleaning solution dispenser 204 may not be part of the cleaner 202, and may be a separate component in the unit 118 (as shown in FIG. 2). In yet another aspect, the cleaning solution dispenser 204 may not be part of the unit 118, and may be a separate component that may be disposed in proximity to the unit 118 on the housing top and bottom walls 108, 110.

In one exemplary aspect, the cleaner 202 may be configured to clean, dry and buff the lens 104 by itself. In this case, the cleaner 202 may clean the lens 104 when the cleaning solution dispenser 204 may be dispensing the cleaning solution on the lens 104, and then dry and buff the lens 104 after the cleaning solution dispenser 204 stops dispensing the cleaning solution. In this aspect, the cleaner 202 may be include a plurality of soft cleaning bristles 206 (that may be made of plastic, fiber, or any other similar flexible material) that may touch the lens 104 and spin/rotate at a high speed when the cleaner 202 is activated. When the cleaning solution dispenser 204 may be dispensing the cleaning solution on the lens 104, the bristle 206 spinning may enable the cleaner 202 to clean the lens 104. When the cleaning solution dispenser 204 is done dispensing the cleaning solution, the bristle 206 spinning may dry and buff the lens 104.

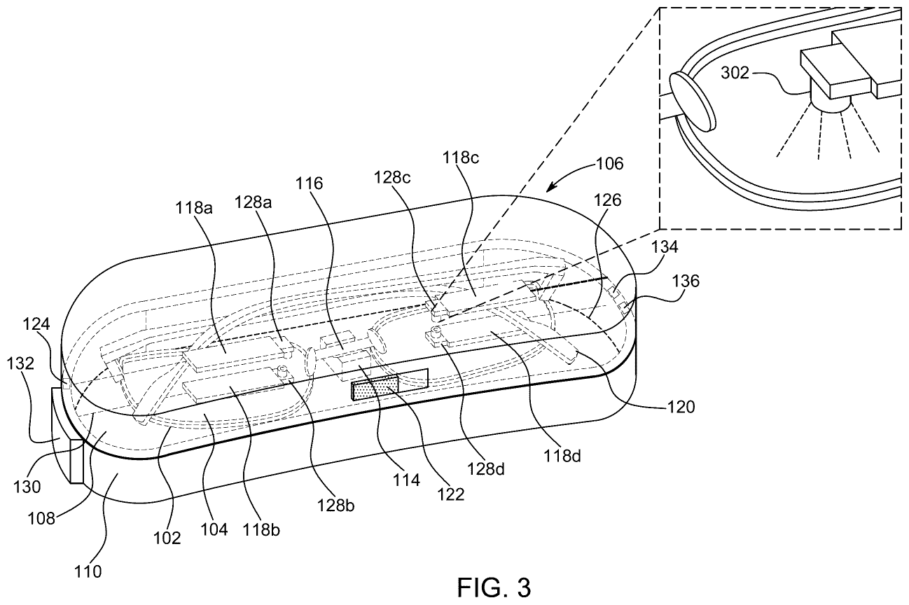

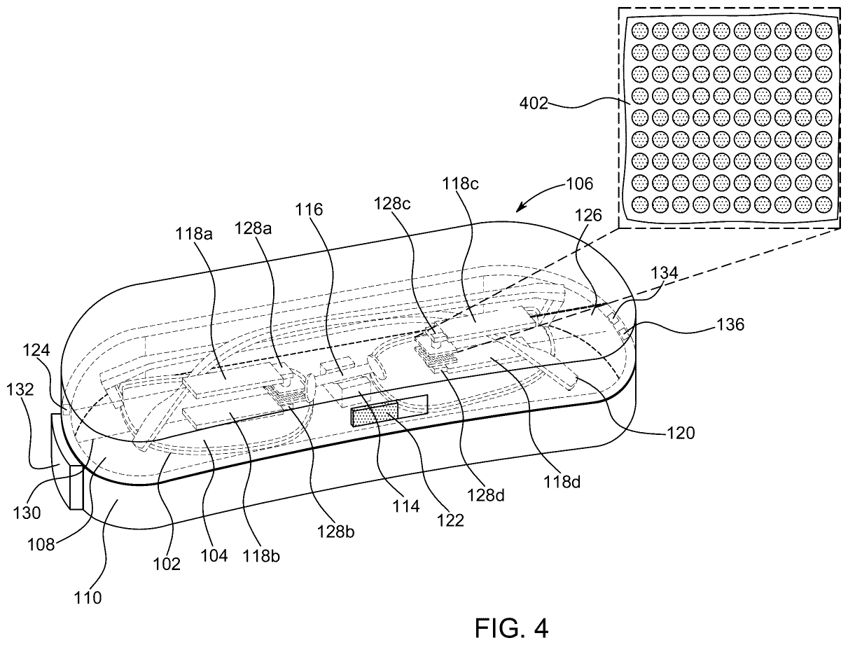

In another exemplary aspect, the cleaner 202 may be configured to clean the lens 104 when the cleaning solution dispenser 204 may be dispensing the cleaning solution on the lens 104; however, the steps of drying and buffing the lens 104 may be performed by other/separate apparatus components, as depicted in FIGS. 3 and 4, and described later in the description below.

In some aspects, the cleaner 202 may be configured to move between a retracted position and an extended position. In the extended position, the cleaner 202 may be disposed over (or above) and in proximity to the lens 104 (as shown in FIG. 2), and the bristles 206 may touch the lens 104. Further, in the retracted position, the cleaner 202 may be disposed away from the lens 104. In an exemplary aspect, the cleaner 202 may be disposed inside the unit 118 (as shown in FIG. 1), when the cleaner 202 may be in the retracted position. The cleaner 202 move from the retracted position to the extended position when the cleaner 202 may be activated, and may move back to the retracted position when the cleaner 202 may be deactivated. In some aspects, the cleaner 202 may include a telescopic rod 208 that may enable the cleaner 202 to extend its length and be disposed in proximity to the lens 104 in the extended position. Specifically, a rod length of the telescopic rod 208 may be adjusted based on a distance between the cleaner 202 (specifically the bristles 206) and the lens 104 surface, such that the bristles 206 touch the lens 104 surface when the cleaner 202 is in the extended position. Since the lens 104 may be of different shapes and sizes, the telescopic rod 208 enables the cleaner 202/bristles 206 to touch the lens 104 irrespective of the lens' dimensions/shape when the cleaner 202 is in the extended position, thereby enabling efficient lens 104 cleaning.

The cleaner 202 may be configured to move in a predefined pattern when the cleaner 202 is in the extended position, the bristles 206 touch the lens 104 surface and the cleaner 202 is activated, to enable the cleaner 202 to clean the lens 104. The cleaner 202 movement in the predefined pattern causes the bristles 206 to also move in the predefined pattern on the lens 104, thereby efficiently cleaning the lens 104. In the aspect where the cleaner 202 is configured to clean the lens 104 (and not dry and buff the lens 104), the cleaning solution dispenser 204 may start to dispense the cleaning solution when the cleaner 202 moves to the extended position, and the cleaner 202 may continue to move in the predefined pattern to clean the lens 104 till the cleaning solution dispenser 204 is dispensing the cleaning solution. In other aspects, the cleaner 202 may continue to move in the predefined pattern for a short additional time duration even after the cleaning solution dispenser 204 stops dispensing the cleaning solution on the lens 104.

The predefined pattern described above may include, for example, a back-and-forth movement, an up-and-down movement, a circular or spinning movement, and/or the like. A person ordinarily skilled in the art may appreciate that when the cleaning solution is being dispensed on the lens 104 and the bristles 206 touch the lens 104 and move in the predefined pattern, dirt, smudges, etc. disposed on the lens 104 may get effectively removed. Further, since the bristles 206 are soft, the bristle movement does not cause scratches on the lens 104, when the bristles 206 move in the predefined pattern touching the lens 104.

In the aspect where the cleaner 202 is configured to clean the lens 104 (and not dry and buff the lens 104), the cleaner 202 may stop its movement in the predefined pattern and move back to the retracted position, when the cleaner 202 is deactivated and/or when the cleaning solution dispenser 204 stops dispensing the cleaning solution (or a short additional time duration after the cleaning solution dispenser 204 stops dispensing the cleaning solution). Responsive to the cleaner 202 moving back to the retracted position, a first moisture removal unit 302 (shown in FIG. 3) may move to an extended position.

In some aspects, the first moisture removal unit 302 may be configured to remove moisture (e.g., most of the moisture) that may be left behind on the lens 104 after the cleaner 202 has cleaned the lens 104 and moved back to the retracted position. The first moisture removal unit 302 may include, for example, a sponge, an absorbent microfiber cloth, a plurality of bristles (similar to the bristles 206), an air blowing unit (as shown in FIG. 3), a combination thereof, and/or the like. In one exemplary aspect, the first moisture removal unit 302 may include a microfiber cloth surrounded by a plurality of bristles. In this case, the first moisture removal unit 302 may be configured to touch the lens 104 when the first moisture removal unit 302 is in the extended position and is activated, thereby effectively absorbing the moisture off the lens 104. In addition, the first moisture removal unit 302 may move in the same predefined pattern described above in the context of the cleaner 202, when the first moisture removal unit 302 touches the lens 104 and is activated, to enable effective lens 104 drying. In another exemplary aspect, when the first moisture removal unit 302 includes the air blowing unit, the first moisture removal unit 302 may blow hot air towards the lens 104, which may dry most of the moisture off the lens 104. In this case, the first moisture removal unit 302 may not be required to touch the lens 104, and may be disposed a predefined non-zero distance away from the lens 104 so that the hot air may reach and contact the entire surface (including corners) of the lens 104.

Similar to the cleaner 202, the first moisture removal unit 302 may also be configured to move between a retracted position and an extended position. The first moisture removal unit 302 may get disposed over (or above) and in proximity to the lens 104 in the extended position, and may be disposed away from the lens 104 in the retracted position. In some aspects, the first moisture removal unit 302 may be disposed inside the unit 118 in the retracted position, as shown in FIG. 1. The first moisture removal unit 302 may move to the extended position when the first moisture removal unit 302 is activated, and may move to the retracted position when the first moisture removal unit 302 is deactivated. The first moisture removal unit 302 may be configured to remove the moisture off the lens 104 when the first moisture removal unit 302 is moved to the extended position and when the first moisture removal unit 302 is activated (or is in the activated state). For example, the first moisture removal unit 302 may be configured to move in the predefined pattern touching the lens 104 (when the first moisture removal unit 302 includes the bristles and/or the microfiber cloth), when the first moisture removal unit 302 is moved to the extended position and is activated. Stated another way, the first moisture removal unit 302 (or its associated bristles and/or the microfiber cloth) may move back-and-forth, up-and-down or in a circular motion to remove the moisture from the lens 104, when the first moisture removal unit 302 is moved to the extended position and is activated. As another example, the first moisture removal unit 302 may blow hot air towards the lens 104 (when the first moisture removal unit 302 includes the air blowing unit), when the first moisture removal unit 302 is moved to the extended position and is activated.

Further, similar to the cleaner 202, the first moisture removal unit 302 may also include a telescopic rod (similar to the rod 208) whose length may be adjusted based on the distance between the first moisture removal unit 302 and lens 104, as described above.

The first moisture removal unit 302 may be activated for a predefined time duration, after which the first moisture removal unit 302 may move back to the retracted position. Stated another way, the first moisture removal unit 302 may be caused to operate and remove the moisture off the lens 104 for a predefined time duration, after which the first moisture removal unit 302 may be deactivated and caused to move back to the retracted position.

In some aspects, after the first moisture removal unit 302 moves to the retracted position, a second moisture removal unit 402 may move to an extended position, as shown in FIG. 4. The second moisture removal unit 402 may be configured to completely dry the lens 104 after the first moisture removal unit 302 removes most of the moisture from the lens 104 (and is deactivated and caused to move back to the retracted position). The second moisture removal unit 402 may be, for example, a dry microfiber cloth, a plurality of bristles (similar to the bristles 206), a combination thereof, and/or the like, and may be a separate unit different from the first moisture removal unit 302.

The second moisture removal unit 402 may be configured to touch the lens 104 when the second moisture removal unit 402 is activated, thereby completely drying the lens 104. In addition, the second moisture removal unit 402 may move in the same predefined pattern described above in the context of the cleaner 202, when the second moisture removal unit 402 touches the lens 104 and is activated, to enable complete lens 104 drying. In this manner, by using the cleaner 202, the first moisture removal unit 302, and the second moisture removal unit 402, the apparatus 100 is able to clean and completely dry the lens 104. The second moisture removal unit 402 is useful to dry any residual moisture that may have been left behind on the lens 104 after the first moisture removal unit 302 removes moisture off the lens 104, thereby ensuring that the lens 104 is completely dry.

Similar to the cleaner 202 and the first moisture removal unit 302, the second moisture removal unit 402 may also be configured to move between a retracted position and an extended position. The second moisture removal unit 402 may get disposed over (or above) and in proximity to the lens 104 in the extended position, and may be disposed away from the lens 104 in the retracted position. In some aspects, the second moisture removal unit 402 may be disposed inside the unit 118 in the retracted position, as shown in FIG. 1. The second moisture removal unit 402 may move to the extended position when the second moisture removal unit 402 is activated, and may move to the retracted position when the second moisture removal unit 402 is deactivated. The second moisture removal unit 402 may be configured to completely dry the lens 104 when the second moisture removal unit 402 is moved to the extended position and when the second moisture removal unit 402 is activated (or is in the activated state). For example, the second moisture removal unit 402 may be configured to move in the predefined pattern touching the lens 104 when the second moisture removal unit 402 is moved to the extended position and is activated. Stated another way, the second moisture removal unit 402 (or its associated bristles and/or the microfiber cloth) may move back-and-forth, up-and-down or in a circular motion to completely dry the lens 104, when the second moisture removal unit 402 is moved to the extended position and is activated.

Further, similar to the cleaner 202 and the first moisture removal unit 302, the second moisture removal unit 402 may also include a telescopic rod (similar to the rod 208) whose length may be adjusted based on the distance between the second moisture removal unit 402 and lens 104, as described above.

The second moisture removal unit 402 may be activated for a predefined time duration, after which the second moisture removal unit 402 may move back to the retracted position. Stated another way, the second moisture removal unit 402 may be caused to operate and completely dry the lens 104 for a predefined time duration, after which the second moisture removal unit 402 may be deactivated and caused to move back to the retracted position.

In some aspects, the apparatus 100 may include one or more additional components that may enable the apparatus 100 to efficiently clean and dry the lens 104. Examples of such components include, but are not limited to, a filtering unit 124, a liquid passage 126, component drying units 128a, 128b, 128c, 128d (collectively referred to as component drying unit 128), a liquid pipe 130, a cleaning solution reservoir 132, a controller 134, a timer 136, and/or the like.

The liquid passage 126 may be disposed on the housing bottom wall interior surface (e.g., on the periphery of the housing bottom wall interior surface), and may be configured to collect the cleaning solution that may fall on the housing bottom wall 110 when the cleaning solution dispenser 204 may be dispensing the cleaning solution and the cleaner 202 may be cleaning the lens 104. In some aspects, the liquid passage 126 may also be disposed on the housing top wall interior surface. The liquid passage 126 may be connected with the filtering unit 124, and may be configured to transfer the collected cleaning solution to the filtering unit 124. Stated another way, the filtering unit 124 may receive the cleaning solution that may be collected in the housing 106 via the liquid passage 126.

The filtering unit 124 may be configured to filter the cleaning solution after the cleaner 202 cleans the lens 104. Specifically, the filtering unit 124 may be configured to filter the cleaning solution that may be received via the liquid passage 126, so that dust, debris, etc. included in the cleaning solution as a result of lens cleaning may be filtered out from the cleaning solution. Responsive to filtering the cleaning solution, the filtering unit 124 may transfer the filtered (or clean) cleaning solution to the cleaning solution reservoir 132, which may be configured to store the clean cleaning solution.

The cleaning solution reservoir 132 may be shaped as a cuboidal or cylindrical container, and may be disposed inside or outside the housing 106. Further, the cleaning solution reservoir 132 may be attached to the housing 106, or may be connected to the housing 106 via one or more pipes or tubes (not shown) that may be configured to transfer the cleaning solution to and from the cleaning solution reservoir 132. In some aspects, the cleaning solution reservoir 132 may be attached to each unit 118 or each cleaning solution dispenser 204 via the liquid pipe 130, and may be configured to supply the clean cleaning solution to the cleaning solution dispenser 204 (e.g., when the cleaning solution dispenser 204 is activated), which may be dispensed by the cleaning solution dispenser 204 on the lens 104, as described above. Specifically, in an exemplary aspect, the cleaning solution dispenser 204 and/or the unit 118 may include a pump that may “pull” the clean cleaning solution from the cleaning solution reservoir 132 via the liquid pipe 130 when the cleaning solution dispenser 204 is activated, and then dispense the received clean cleaning solution on the lens 104. In this manner, the cleaning solution is filtered, circulated and re-used inside the apparatus 100 to ensure that the cleaning solution is not required to be replaced frequently.

In some aspects, after using the apparatus 100 for more than a predefined count of times (e.g., 30-40 times), the user may replace the cleaning solution from the cleaning solution reservoir 132, and add new cleaning solution to the cleaning solution reservoir 132. In further aspects, the cleaning solution reservoir 132 may include a concentrated cleaning solution (e.g., in a cartridge), which may take the form of the liquid cleaning solution described above when water may be added to the concentrated cleaning solution. In this case, the user may be required to replace water in the cleaning solution reservoir 132 after a few uses (e.g., after 10-15 uses), and may be required to replace the concentrate less frequently (e.g., after 50-100 uses). In some aspects, the cleaning solution reservoir 132 may be detachable from the housing 106, so that the user may conveniently re-fill the water after detaching the cleaning solution reservoir 132 and then re-attach the cleaning solution reservoir 132 to the housing 106 when the water is filled.

In alternative aspects, the apparatus 100 may not include the cleaning solution reservoir 132, or the cleaning solution reservoir 132 may be disposed inside the housing 106 walls/body. In this case, the housing 106 body may hold the cleaning solution, which may be dispensed by the cleaning solution dispenser 204 upon activation. Such a configuration may assist in reducing the noise of the pumps and/or the motors required to pump the cleaning solution in the apparatus 100, when the apparatus 100 may be activated.

The controller 134 may include a processor and a memory (not shown), and may be configured to control operation of each apparatus component (e.g., the cleaner 202, the first and second moisture removal units 302, 402, the cleaning solution dispenser 204, and/or the like) based on inputs obtained from the timer 136 and/or the switch 122. The memory may store programs in code and/or store data for performing various apparatus operations in accordance with the present disclosure. Specifically, the processor may be configured and/or programmed to execute computer-executable instructions stored in the memory for performing various apparatus functions in accordance with the disclosure. Consequently, the memory may be used for storing code and/or data code and/or data for performing operations in accordance with the present disclosure.

In one or more aspects, the processor may be disposed in communication with the memory, which may include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory may be one example of a non-transitory computer-readable medium and may be used to store programs in code and/or to store data for performing various operations in accordance with the disclosure. The instructions in the memory may include one or more separate programs, each of which may include an ordered listing of computer-executable instructions for implementing logical functions. The controller's operation is described below.

When the user closes the apparatus 100 and activates the switch 122, the switch 122 may transmit an activation signal to the controller 134. Responsive to receiving the activation signal from the switch 122, the controller 134 may transmit command signals to the cleaner 202, the cleaning solution dispenser 204, and the timer 136. The timer 136 may start a predefined first countdown responsive to receiving the command signal from the controller 134. Further, the cleaning solution dispenser 204 may move to the extended position and get disposed over the lens 104 and get activated, responsive to receiving the command signal from the controller 134. Responsive to getting activated, the cleaning solution dispenser 204 may commence to dispense the cleaning solution on the lens 104. Furthermore, the cleaner 202 may move to the extended position and get disposed over the lens 104 and get activated, responsive to receiving the command signal from the controller 134. Responsive to getting activated, the cleaner 202 may move in the predefined pattern described above to clean the lens 104.

After the predefined first countdown stops, the timer 136 may transmit a first signal to the controller 134. Responsive to receiving the first signal, the controller 134 may transmit another command signal to the cleaning solution dispenser 204 to stop dispensing the cleaning solution and move back to the retracted position. In some aspects, when the cleaner 202 is configured to clean the lens 104 and not dry and buff the lens 104, the controller 134 may transmit another command signal to the cleaner 202 to stop moving in the predefined pattern and move back to the retracted position responsive to receiving the first signal from the timer 136. On the other hand, when the cleaner 202 is configured to clean, dry and buff the lens 104, the controller 134 may enable the cleaner 202 to continue moving in the predefined pattern for a preset time duration after receiving the first signal from the timer 136, so that the cleaner 202 may effectively dry and buff the lens 104.

When the cleaner 202 is configured to clean the lens 104 and not dry and buff the lens 104, the controller 134 may transmit another command signal to the timer 136 and the first moisture removal unit 302 responsive to receiving the first signal from the timer 136. Responsive to receiving the command signal, the timer 136 may start a predefined second countdown. Further, responsive to receiving the command signal from the controller 134, the first moisture removal unit 302 may move to the extended position and get disposed over the lens 104 and get activated. Responsive to getting activated, the first moisture removal unit 302 may move in the predefined pattern (or blow hot air) and remove most of the moisture off the lens 104, as described above.

After the predefined second countdown stops, the timer 136 may transmit a second signal to the controller 134. Responsive to receiving the second signal, the controller 134 may transmit another command signal to the timer 136, the first moisture removal unit 302 and the second moisture removal unit 402. Responsive to receiving the command signal, the timer 136 may start a predefined third countdown. Further, responsive to receiving the command signal from the controller 134, the first moisture removal unit 302 may get deactivated (i.e., stop moving in the predefined pattern and/or blowing hot air) and move back to the retracted position. Furthermore, responsive to receiving the command signal from the controller 134, the second moisture removal unit 402 may move to the extended position and get disposed over the lens 104 and get activated. Responsive to getting activated, the second moisture removal unit 402 may move in the predefined pattern and dry the lens 104, as described above

After the predefined third countdown stops, the timer 136 may transmit a third signal to the controller 134. Responsive to receiving the third signal, the controller 134 may transmit another command signal to the second moisture removal unit 402, causing the second moisture removal unit 402 to get deactivated (i.e., stop moving in the predefined pattern) and move back to the retracted position. Further, responsive to receiving the third signal, the controller 134 may output an audible or visual alarm notification (e.g., via an apparatus speaker and/or a lighting unit, not shown), indicating to the user that the apparatus 100 is done cleaning, drying and buffing the lens 104, and hence the user may open the apparatus 100 and take out the “clean” eyeglasses 102. In this manner, the apparatus 100 enables automatic eyeglasses 102/lens 104 cleaning.

In additional aspects, responsive to receiving the third signal from the timer 136, the controller 134 may transmit an activation signal to each component drying unit 128. The component drying unit 128 may be configured to dry the cleaner 202, and the first and second moisture removal units 302, 402 after use, so that these components are ready to use in an optimal state for the next cleaning and drying cycle. The component drying unit 128 may perform the action described above by twisting or compressing the bristles and/or cloth included in the cleaner 202, and/or the first and second moisture removal units 302, 402, and then by air drying or heating these components. In an exemplary aspect, the component drying unit 128 may include an air blowing unit, a heating unit, an absorbent chemical spraying unit, and/or the like to effectively dry the apparatus components. If an absorbent chemical is used to dry the components, the chemical will be required to be drained and refilled periodically. Further, in this case, the housing 106 will be properly ventilated.

In some aspects, the apparatus 100 may not include the component drying unit 128, when, for example, the cleaner 202 does the cleaning, drying and buffing by itself. Stated another way, the apparatus 100 may not include the component drying unit 128 when the apparatus 100 does not include the first and second moisture removal units 302, 402.

The apparatus 100 may further include additional components such as motors, pumps, batteries, etc., which may enable efficient apparatus operation. The motors may be configured to enable the cleaner 202, the cleaning solution dispenser 204, and the first and second moisture removal units 302, 402 to move between the retracted and extended positions. The pumps may be configured to circulate the cleaning solution in the housing interior portion as described above. Further, the batteries may be configured to power the various apparatus components described above.

Furthermore, each of the cleaner 202, and the first and second moisture removal units 302, 402 may include a spring mechanism that may enable application of adequate pressure on the lens 104 when these components touch the lens 104, while at the same time ensuring that the lens 104 is not damaged. The spring mechanism may factor-in different eyeglasses designs; specifically, different distances between these components and the lens surface. In other aspects, a pump mechanism, instead of or along with the spring mechanism, may be used to apply the adequate pressure described above.

In further aspects, the housing 106 may be waterproof, so that the cleaning solution does not escape the housing 106 when the apparatus 100 is operating (or even afterwards).

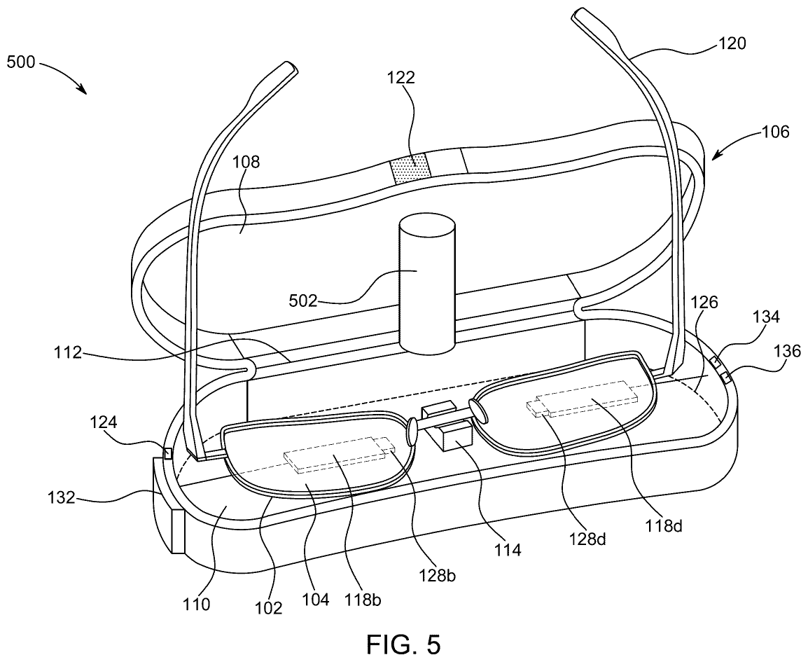

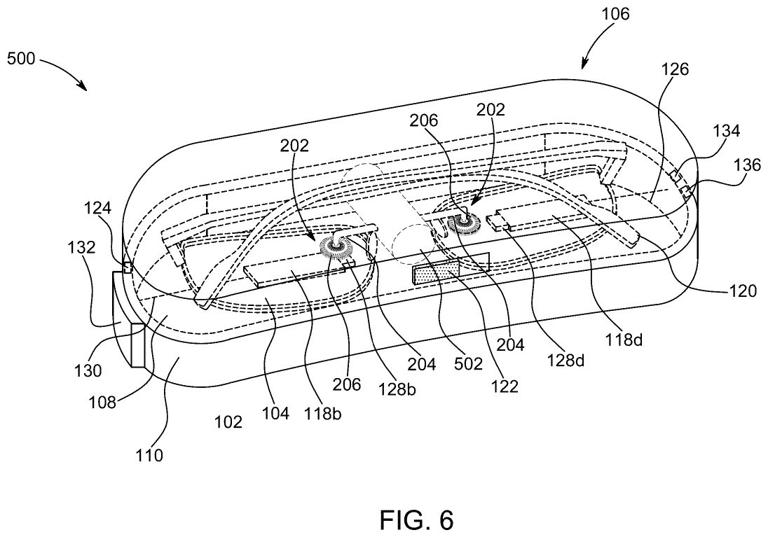

FIG. 5 depicts an example second eyewear cleaning apparatus 500 (or apparatus 500) in an open state in accordance with the present disclosure. FIG. 5 will be described in conjunction with FIG. 6.

The apparatus 500 may be similar to the apparatus 100; however, instead of having the units 118a and 118c on the housing top wall 108, the apparatus 500 may include a holding unit 502 that may be disposed on the housing top wall 108, the housing bottom wall 110 or the intersection edge 112.

The holding unit 502 may be shaped as a cylindrical or cuboidal rod, which may have a length equivalent to or less than a housing top/bottom wall width. The holding unit 502 may be pivotally connected to the housing top wall 108, the housing bottom wall 110 or the intersection edge 112, such that the holding unit 502 may move/rotate between a first position (as shown in FIG. 5) and a second position (as shown in FIG. 6). In the first position, the holding unit 502 may be disposed in proximity to (and/or parallel to) to the housing top wall 108 and away from the housing bottom wall 110, when the apparatus 100 is in the open state. In the second position, the holding unit 502 may be disposed in proximity to (and/or parallel to) to the housing bottom wall 110.

During operation, the user may move the apparatus 500 to the open state and then move the holding unit 502 to the first position. The user may then place the eyeglasses 102 in the facedown position on the housing bottom wall 110, while keeping the eyeglasses temples 120 open, as shown in FIG. 5. The user may then rotate/move the holding unit 502 to the second position and close the eyeglasses temples 120, before moving the apparatus 100 to the closed state, as shown in FIG. 6. In this configuration, the holding unit 502 may get disposed between the eyeglasses temples 120 and the eyeglasses bridge 116, when the eyeglasses 102 are placed inside the housing 106 in proximity to the housing bottom wall 110 and the holding unit 502 is in the second position.

Furthermore, in the apparatus 500, the units 118a and 118c and the corresponding cleaning solution dispensers may be part of the holding unit 502. Specifically, in the apparatus 500, the cleaner 202, the cleaning solution dispenser 204, and the first and second moisture removal units 302, 402 may be part of the holding unit 502. In this case, the cleaner 202, the cleaning solution dispenser 204, and the first and second moisture removal units 302, 402 may extend horizontally in the left and right directions from the holding unit 502 when activated, and then move “downwards” vertically to be disposed in proximity to the left and right lenses 104, as shown in FIG. 6. Responsive to being disposed in proximity to the left and right lenses 104, the cleaner 202, the cleaning solution dispenser 204, and the first and second moisture removal units 302, 402 may perform the same actions as described above to clean, dry and buff the lens 104.

The apparatus 500 is specifically used for those eyeglasses that may have a curved shape (and may not be the standard “flat” eyeglasses), or may have a considerable distance (e.g., more than a predefined distance threshold) between the lens 104 and the eyeglasses temples 120 or between the eyeglasses bridge 116 and the eyeglasses temples 120 (when the eyeglasses temples 120 are closed). For such eyeglasses, having the cleaner 202, the cleaning solution dispenser 204, and/or the first and second moisture removal units 302, 402 extend from the housing top wall 108 may not enable optimal lens cleaning, as the eyeglasses temples 120 may interrupt or interfere with the movement of these components. Therefore, to enable optimal lens cleaning for such eyeglasses, the apparatus 500 may include the holding unit 502 that stably places and secures the eyeglasses 102 in the housing 106, and at the same time ensures that the movement of apparatus components described above are not interrupted (as the components are part of the holding unit 502 and not extended from the housing top wall 108).

In alternative aspects, instead of the holding unit 502 being configured to move/rotate between the first position and the second position as described above, the holding unit 502 may be configured to slide in and out from the housing 106 wall. In this case, when the apparatus 500 may be activated, the holding unit 502 may automatically slide out from the housing 106 and get disposed in the second position shown in FIG. 6. Further, in this case, the user may not be required to place the eyeglasses 102 in the facedown position on the housing bottom wall 110 while keeping the eyeglasses temples 120 open, but may instead place the eyeglasses 102 in the facedown position on the housing bottom wall 110 while keeping the eyeglasses temples 120 closed.

In this aspect, when the user places the eyeglasses 102 on the clip 114 with the eyeglasses temples 120 closed and closes the apparatus 500, the clip 114 may automatically lift the eyeglasses temples 120 slightly. In this case, the clip 114 may have a mechanism/unit that may be activated by the controller 134, and which may be configured to lift the eyeglasses temples 120 slightly upon activation. Responsive to the eyeglasses temples 120 getting lifted, the holding unit 502 may automatically slide out from the housing 106 (e.g., upon being activated by the controller 134) and get disposed in the second position shown in FIG. 6. Thereafter, the apparatus 500 may operate in the same manner as described above.

The example aspect or arrangement/configuration of the holding unit 502 described above enables the eyeglasses 102 to be inserted into the apparatus 500 with the eyeglasses temples 120 closed. Further, this arrangement/configuration of the holding unit 502 may also be used for standard “flat” eyeglasses, in addition to being used for eyeglasses with curved shape. Stated another way, this arrangement/configuration of the holding unit 502 may be used for eyeglasses of any shape and/or size.

Remaining apparatus 500 components are similar to the apparatus 100 components, and hence are not described again here for the sake of simplicity and conciseness.

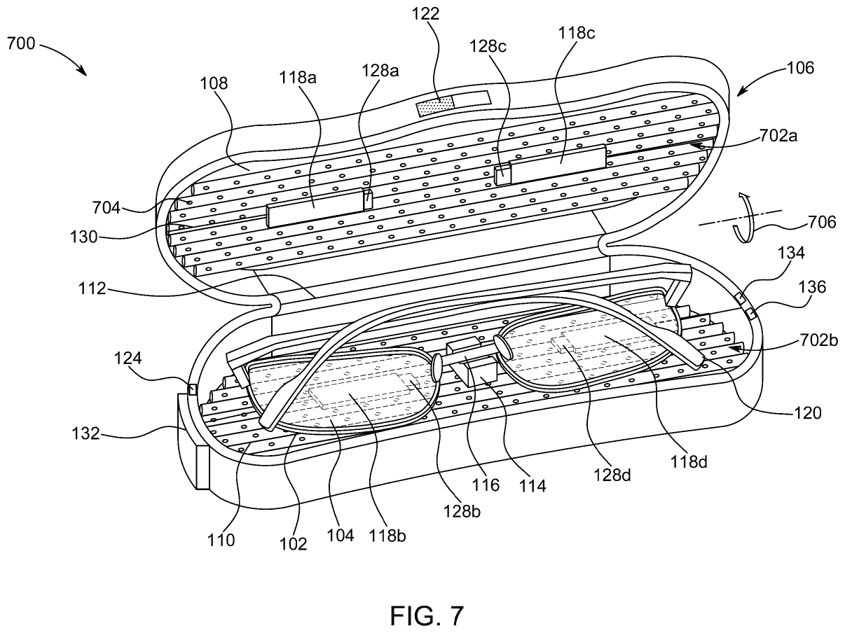

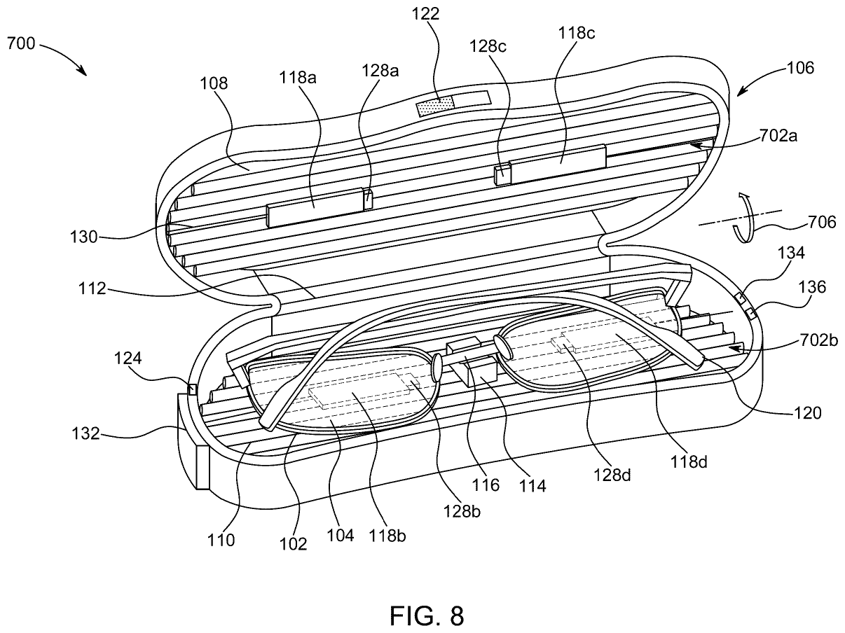

FIG. 7 depicts an example third eyewear cleaning apparatus 700 (or apparatus 700) in a first state in accordance with the present disclosure. FIG. 7 will be described in conjunction with FIG. 8, which depicts the apparatus 700 in a second state.

The apparatus 700 may be similar to the apparatus 100; however, the apparatus 700 may additionally include a first set of tubes 702a disposed on the housing top wall interior surface, and a second set of tubes 702b disposed on the housing bottom wall interior surface, as shown in FIGS. 7 and 8. In some aspects, the first set of tubes 702a may be part of the housing top wall 108, and the second set of tubes 702b may be part of the housing bottom wall 110.

Each tube of the first and second sets of tubes 702a, 702b (collectively referred to as tube 702) may be shaped as a hollow cylinder, which may have a hollow interior portion. In an exemplary aspect, each tube 702 may be made of plastic. The lengths of the tubes 702 may be equivalent to each other, and may be equivalent to a width of the housing top and bottom walls 108, 110. In some aspects, the ends of each tube 702 (which may be open) may be connected to the liquid passage 126.

Further, each tube 702 may include a hole or an opening 704, as shown in FIG. 7. The opening 704 may be configured to receive the cleaning solution when the cleaning solution dispenser 204 may be dispensing the cleaning solution on the lens 104. The cleaning solution enters the hollow interior portion of each tube 702 via the opening 704, and the cleaning solution may then enter the liquid passage 126 via the open ends of each tube 702.

During the apparatus operation, the controller 134 may cause the opening 704 of each tube 702 to face the housing interior portion towards the lens 104 and away from the housing top/bottom wall interior surface, when the cleaning solution dispenser 204 may be dispensing the cleaning solution on the lens 104. In this configuration, the cleaning solution that falls on the lens 104 may enter the tubes 702 via the opening 704, and then get transferred to the liquid passage 126. When the cleaning solution dispenser 204 stops dispensing the cleaning solution on the lens 104 and the cleaner 202 is done cleaning the lens 104, the controller 134 may cause the tubes 702 to axially rotate by 180 degrees (as shown by an arrow 706), so that the openings 704 move away from the housing interior portion/lens 104 and face the housing top/bottom wall interior surface.

Responsive to the openings 704 moving away from the lens 104 or facing the housing top/bottom wall interior surface, the “dry” side of the tubes 702 may face the lens 104 (as shown in FIG. 8), thereby enabling quicker and efficient lens 104 drying (e.g., via the first and second moisture removal units 302, 402).

In some aspects, each tube 702 may be connected with a motor (not shown) that may enable the tube's axial rotation by 180 degrees. In this case, the controller 134 may cause the tube's axial rotation by transmitting command signals to the motor.

Remaining apparatus 700 components are similar to the apparatus 100 components, and hence are not described again here for the sake of simplicity and conciseness.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus comprising:
a housing configured to receive eyeglasses;
a cleaning solution dispenser configured to dispense a cleaning solution on a lens associated with the eyeglasses;
a cleaner configured to clean the lens when the cleaning solution is being dispended on the lens;
a first moisture removal unit configured to remove moisture from the lens after the cleaner cleans the lens; and
a second moisture removal unit configured to dry the lens after the first moisture removal unit removes the moisture from the lens, wherein the second moisture removal unit is different from the first moisture removal unit.

2. The apparatus of claim 1, wherein the cleaner is configured to move between a retracted position and an extended position, wherein the cleaner is disposed over and in proximity to the lens in the extended position and the cleaner is disposed away from the lens in the retracted position, and wherein the cleaner cleans the lens when the cleaner is in the extended position.

3. The apparatus of claim 2, wherein the cleaning solution dispenser is part of the cleaner, and wherein the cleaning solution dispenses the cleaning solution when the cleaner is in the extended position.

4. The apparatus of claim 1, wherein the cleaner comprises a plurality of cleaning bristles, wherein the cleaner is configured to move in a predefined pattern to clean the lens when the plurality of cleaning bristles touches the lens, and wherein the predefined pattern comprises at least one of a back-and-forth movement, an up-and-down movement, or a circular movement.

5. The apparatus of claim 1, wherein each of the first moisture removal unit and the second moisture removal unit is configured to move between a retracted position and an extended position, wherein each of the first moisture removal unit and the second moisture removal unit gets disposed over and in proximity to the lens in the extended position and each of the first moisture removal unit and the second moisture removal unit is disposed away from the lens in the retracted position, and wherein the first moisture removal unit removes the moisture from the lens and the second moisture removal unit dries the lens in the extended position.

6. The apparatus of claim 1, wherein the first moisture removal unit comprises one or more of a sponge, an absorbent microfiber cloth, a plurality of bristles, and an air blowing unit.

7. The apparatus of claim 1, wherein the second moisture removal unit comprises one or more of a plurality of bristles and a dry microfiber cloth.

8. The apparatus of claim 1, wherein each of the first moisture removal unit and the second moisture removal unit is configured to move back-and-forth, up-and-down or in a circular motion to remove the moisture from the lens or dry the lens.

9. The apparatus of claim 1, wherein at least one of the cleaner, the first moisture removal unit or the second moisture removal unit comprises a telescopic rod, wherein a rod length of the telescopic rod is configured to be adjusted based on a distance between the cleaner, the first moisture removal unit or the second moisture removal unit and the lens.

10. The apparatus of claim 1 further comprising a controller and a timer, wherein the controller is configured to control operation of each of the cleaner, the cleaning solution dispenser, the first moisture removal unit, and the second moisture removal unit based on inputs obtained from the timer.

11. The apparatus of claim 1 further comprising a holding unit configured to move between a first position and a second position, wherein the holding unit is disposed in proximity to a housing top wall in the first position, and wherein the holding unit is disposed in proximity to a housing bottom wall in the second position.

12. The apparatus of claim 11, wherein the holding unit is configured to be disposed between eyeglasses temples and an eyeglasses bridge when the eyeglasses are placed inside the housing in proximity to the housing bottom wall and the holding unit is in the second position.

13. The apparatus of claim 11, wherein at least one of the cleaner, the cleaning solution dispenser, the first moisture removal unit, or the second moisture removal unit is part of the holding unit.

14. The apparatus of claim 1 further comprising a component drying unit configured to dry at least one of the cleaner, the first moisture removal unit, or the second moisture removal unit after use, wherein the component drying unit comprises at least one of an air blowing unit, a heating unit or an absorbent chemical spraying unit.

15. The apparatus of claim 1, wherein the housing comprises a housing top wall and a housing bottom wall, wherein the housing top wall comprises a first set of tubes disposed at a top wall interior surface facing a housing interior portion and the housing bottom wall comprises a second set of tubes disposed at a bottom wall interior surface facing the housing interior portion, and wherein each tube of the first set of tubes and the second set of tubes comprises a hollow interior portion.

16. The apparatus of claim 15, wherein each tube of the first set of tubes and the second set of tubes comprises an opening to receive the cleaning solution when the cleaning solution dispenser is dispensing the cleaning solution on the lens, and wherein the cleaning solution enters the hollow interior portion via the opening.

17. The apparatus of claim 16, wherein each tube is configured to axially rotate by 180 degrees after the cleaner cleans the lens.

18. The apparatus of claim 1 further comprising a filtering unit configured to filter the cleaning solution after the cleaner cleans the lens.

19. An apparatus comprising:
a housing configured to receive eyeglasses;
a cleaning solution dispenser configured to dispense a cleaning solution on a lens associated with the eyeglasses;
a cleaner configured to clean the lens when the cleaning solution is being dispended on the lens; and
a holding unit configured to move between a first position and a second position, wherein:
the holding unit is disposed in proximity to a housing top wall in the first position and in proximity to a housing bottom wall in the second position, and
the holding unit is configured to be disposed between eyeglasses temples and an eyeglasses bridge when the eyeglasses are placed inside the housing in proximity to the housing bottom wall and the holding unit is in the second position.

20. An apparatus comprising:
a housing configured to receive eyeglasses, wherein:
the housing comprises a housing top wall and a housing bottom wall,
the housing top wall comprises a first set of tubes disposed in a top wall interior surface facing a housing interior portion and the housing bottom wall comprises a second set of tubes disposed in a bottom wall interior surface facing the housing interior portion, and
each tube of the first set of tubes and the second set of tubes comprises a hollow interior portion;
a cleaning solution dispenser configured to dispense a cleaning solution on a lens associated with the eyeglasses, wherein:
each tube of the first set of tubes and the second set of tubes comprises an opening to receive the cleaning solution when the cleaning solution dispenser is dispensing the cleaning solution on the lens, and
the cleaning solution enters the hollow interior portion via the opening; and
a cleaner configured to clean the lens when the cleaning solution is being dispended on the lens, wherein each tube is configured to axially rotate by 180 degrees after the cleaner cleans the lens.
